(19) United States
(12) Patent Application Publication
(10) Pub. No.: US 2003/0078104 A1
(43) Pub. Date: Apr. 24, 2003

(54) Folding game illumination system

(75) Inventor: Wing Hang Lee, Tai Wai (HK)

Correspondence Address: David G. Beck, McCutchen, Doyle, Brown & Enersen, LLP, Three Embarcadero Center, Suite 1800, San Francisco, CA, 94111, US

(73) Assignee: Radica Games Ltd.

(21) Appl. No.: 10/001,929

(22) Filed: Oct. 23, 2001

(51) Int. Cl. A63F 13/00

(52) U.S. Cl. 463/47

(57) ABSTRACT

An illuminator is provided for use with a hand-held electronic device such as a gaming device. The illuminator includes at least one light attached to one or more brackets which are rotatably secured to the gaming device. When the illumination device is in use, the lights may be moved to various positions, thereby preventing a user's view of a screen from being obstructed and also producing off-axis sources of illumination from various angles. These angles can be changed to minimize glare, to allow the screen to be viewed from various positions or otherwise to suit the needs of the user. The brackets may be moved to positions which conform with the sides of the gaming device. When the brackets are positioned in this manner, they do not increase the overall thickness of the gaming device.

This application relates generally to illumination systems for electronic devices, such as computing, telecommunication and gaming devices, and is particularly directed to illumination systems for hand-held gaming devices.

### BACKGROUND OF THE INVENTION

Hand-held electronic devices, such as computing, telecommunication and gaming devices, are enjoying increasing popularity. Such devices will be referred to herein as “hand-held gaming devices” or simply “gaming devices” for the sake of convenience. However, it will be understood to those of skill in the art that the presently-claimed invention is not limited to use with gaming devices, but also includes personal digital assistants, palm-top computers and other hand-held devices.

Hand-held gaming devices have an intrinsic problem: these devices often use a display such as a non-backlit liquid crystal display (“LCD”) which is difficult to see clearly in low light conditions. SegaGame Gear™ and Nintendo's Game Boy TM and Game Boy Advanced™ all share this drawback.

Battery powered illuminators have become popular devices for overcoming this problem. Such illuminators typically use an incandescent bulb, although some use a white or colored light-emitting diode (“LED”).

For example, one such illuminator uses a battery and “stalk” (a projecting support with a light bulb to illuminate the display). The illuminator's stalk is positioned above the screen when in use and is folded across the top of the gaming device when not in use.

There are several drawbacks to the stalk design. Because the illuminator has only a single light source, it provides uneven illumination. In addition, this design occupies more space than necessary: even when folded over, the overall height of the gaming device is substantially increased. Consequently, the gaming device is not as convenient to carry: a pocket which could accommodate the gaming device may not accommodate the gaming device and the attached illuminator. Also, the batteries tend to alter the balance of the gaming device.

A second prior art illuminator includes both a stalk and a connector which plugs into an expansion port of the gaming device. Because the second device draws power from the gaming device's battery, it is lighter than the previously-described device and does not require an extra battery. However, because the gaming device's battery must also power the second illumination device, the battery must be replaced more often. Also, the design of the second device does not solve the height problem caused by the previously-described device: even when the second device is folded over, the overall height of the gaming device is significantly increased. Moreover, even though the second illuminator has no battery to cause an imbalance, the second illuminator is inherently unbalanced.

A third type of prior art illuminator includes an integrated magnification lens mounted over the display with a built-in light source. The third type of illuminator still has the drawbacks of uneven lighting and increased height.

What is needed is an illumination for a hand-held gaming device which provides even lighting and does not significantly add to the overall height of the gaming device.

### SUMMARY OF THE INVENTION

According to one aspect of the invention, an illuminator for a hand-held electronic device includes at least one light source attached to a first bracket which is rotatably secured to the gaming device. When the illumination device is in use, the bracket may be moved to various positions above the gaming device, thereby producing an off-axis source of illumination from various angles. Such off-axis illumination can significantly decrease glare as compared to prior art illuminators. The bracket may be moved to a position which is adjacent to and in conformity with at least a second side and a third side of the hand-held electronic device. This position is advantageous for storage because when the brackets are in this position they do not add to the overall thickness of the hand-held electronic device.

According to another aspect of the invention, an illuminator for a gaming device includes at least two light sources attached to a first bracket and a second bracket. In one such embodiment, the first and second brackets are rotatably secured to a frame by radial grooves and ridges in the brackets which cooperate with radial grooves and ridges in the frame. In another such embodiment, the first and second brackets are rotatably secured to the frame by one or more tabs which project from the brackets and cooperate with slots in the frame. In still another such embodiment, the first and second brackets are rotatably secured to the frame by one or more tabs which project from the frame and cooperate with slots in the brackets. When the illumination device is in use, the brackets may be moved to various positions above the gaming device, thereby producing two off-axis sources of illumination from various angles. These angles can be changed to minimize glare, to allow viewing from various angles or to otherwise suit the needs of the user.

According to some embodiments of the present invention, the brackets may be moved to positions on opposing sides of the gaming device. According to other embodiments of the present invention, the brackets may be moved to positions at the top and bottom of the gaining device. In either such embodiment, when the illuminator is moved to these positions, the illuminator does not increase the overall thickness of the gaming device.

According to some embodiments of the present invention, at least one of the light sources is rotatable with respect to the bracket to which the light source is attached.

According to some embodiments of the present invention, a battery is provided for the illumination device. In preferred embodiments, the battery is located underneath the gaming device and is located near the center of mass of the gaming device, thereby maintaining the balance of the gaming device when it is used with the illumination device.

### BRIEF DESCRIPTION OF THE DRAWINGS

FIG. 1 is a side view of one embodiment of the illuminator of the present invention, shown when the illuminator is in position for use.

FIG. 2 is a side view of one embodiment of the illuminator of the present invention, shown when the illuminator is not in use.

FIG. 3 is a side view of an embodiment of the present invention which includes a battery pack.

FIG. 4 is a bottom view of an embodiment of the present invention which includes a battery pack.

FIG. 5 is a perspective view of an embodiment of the present invention which includes a battery pack and two brackets.

FIG. 6 is a perspective view of an embodiment of the present invention which includes a single bracket.

FIG. 7 is an illustration of one embodiment of an illuminator according to the present invention, wherein the light is rotatable with respect to the bracket.

FIG. 8 is an illustration of one embodiment of an illuminator according to the present invention, wherein the light is rotatable with respect to the bracket and wherein the light has been rotated to allow the light sources to be displayed.

FIG. 9 is an illustration of one embodiment of sections of a bracket and a frame for an illuminator according to the present invention, wherein the bracket and frame include cooperating radial grooves for positioning the bracket.

FIG. 10 is an illustration of one embodiment of sections of a bracket and a frame for an illuminator according to the present invention, wherein the bracket includes a tab and the frame includes cooperating slots for positioning the bracket.

FIG. 11 is a bottom view of an embodiment of the present invention wherein the frame is secured to a hand-held electronic device by straps.

### DESCRIPTION OF THE SPECIFIC EMBODIMENTS

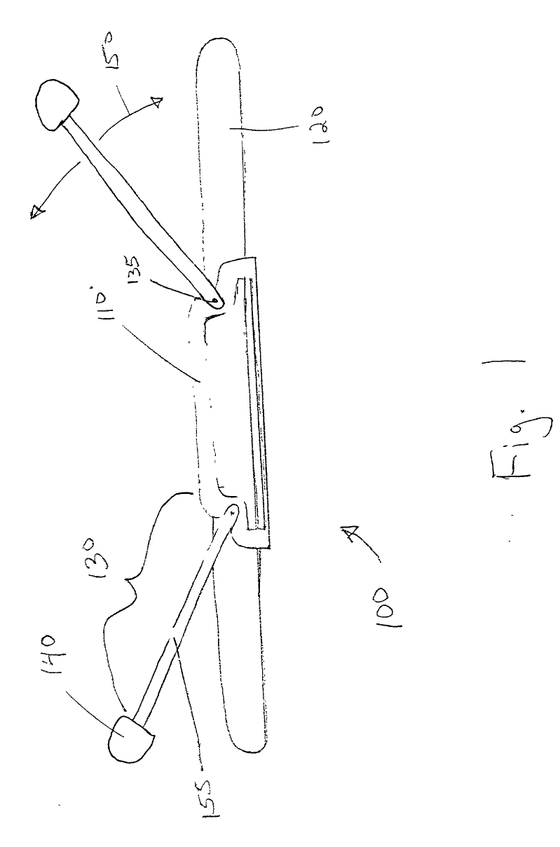

FIG. 1 is a side view of illuminator 100 according to one embodiment of the present invention. Illuminator 100 includes frame 110, which is shown engaged with gaming device 120. It will be readily appreciated by those of skill in the art that gaming device 120 is not part of illuminator 100, but that instead illuminator 100 is an accessory which has been attached to gaming device 120. In some embodiments, frame 110 is a single piece of material, such as plastic, which can be expanded to accommodate the gaming device and which will hold the gaming device into place by compressional force, by tabs, brackets or similar means.

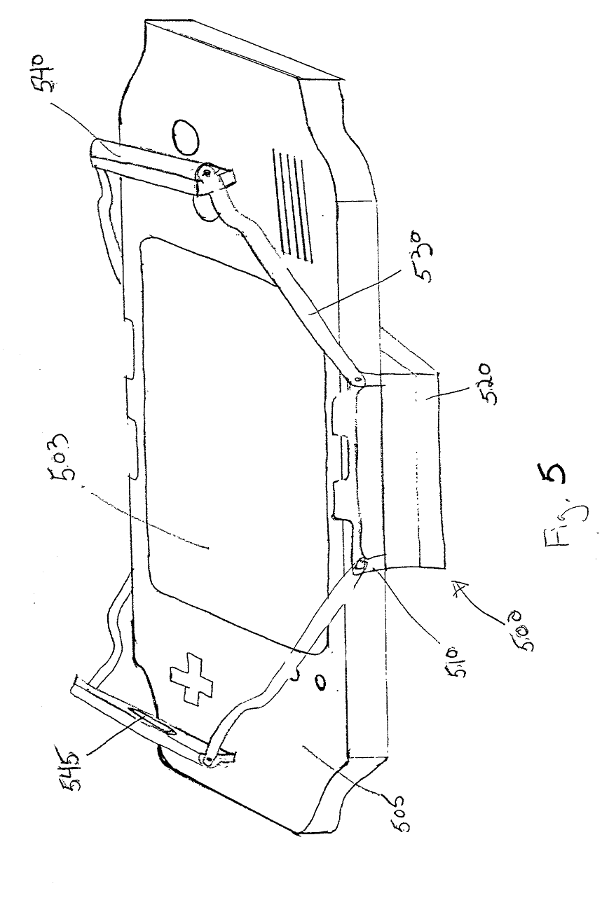

In FIG. 1, only one side of gaming device 120 is shown. Screen 125 of gaming device 120 is not visible in FIG. 1, but screen 125 is on a side of gaming device 120 which faces the top of FIG. 1. In FIG. 1, only one arm 155 of each bracket 130 is shown, but in the embodiment shown in FIG. 1, there is a corresponding arm 155 parallel to each arm 155 shown in FIG. 1 attached to the opposing side of frame 110. This feature will be better appreciated with reference to FIG. 5.

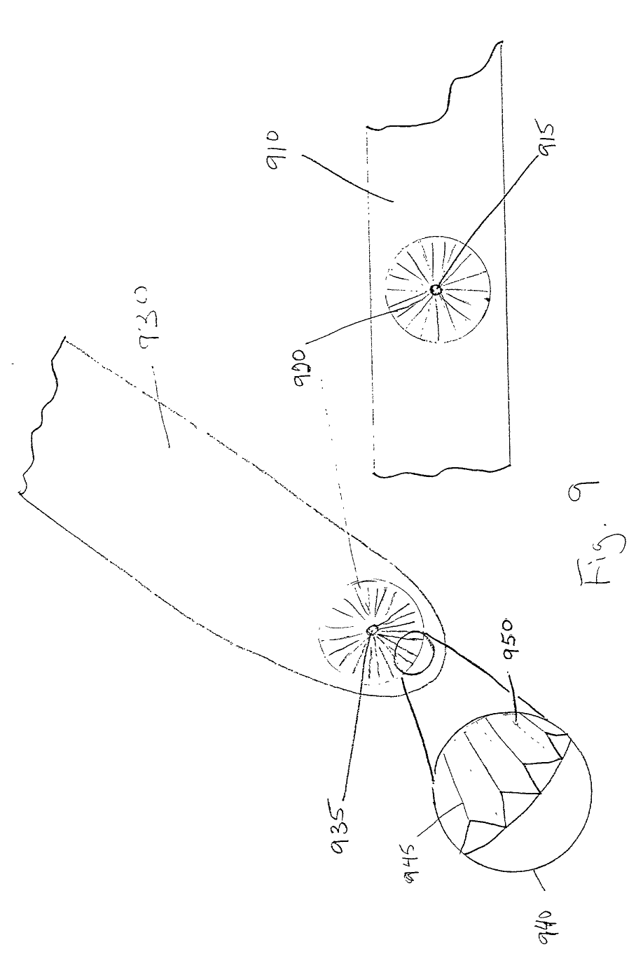

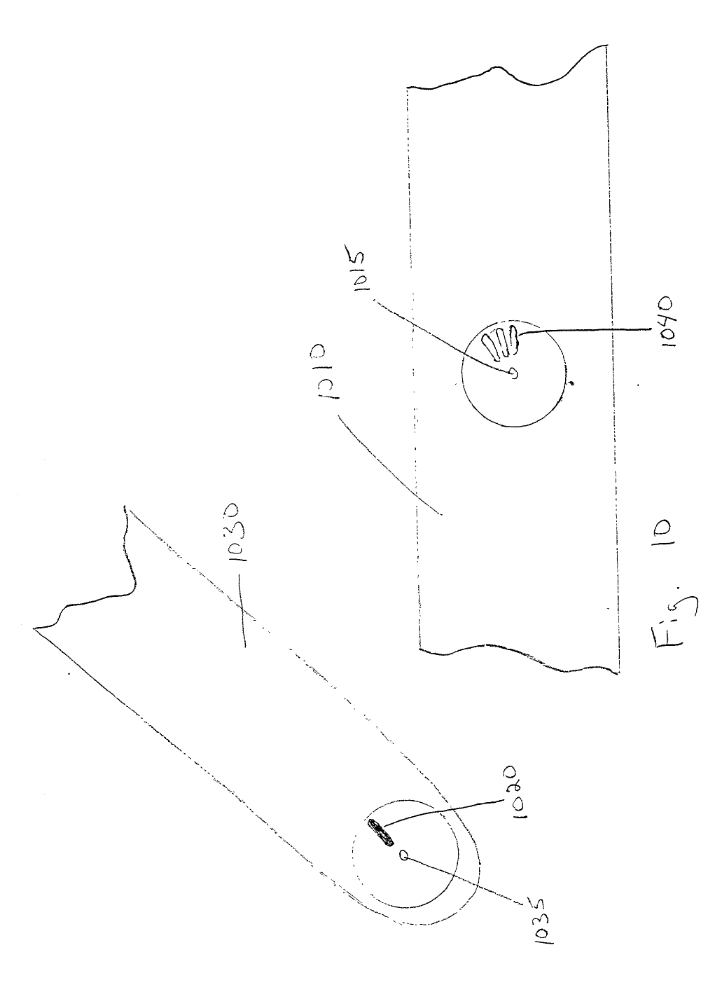

Brackets 130 are attached for rotation to frame 110 by pin 135. One of skill in the art will readily imagine other devices for attaching brackets 130 for rotation to frame 110, including hinges, swivels, rods, ball joints, etc. FIGS. 9 and 10 and the accompanying description provide more detail concerning how brackets 130 may be attached to frame 110.

Lights 140 may be attached to brackets 130 in any of the ways described herein for attaching brackets 130 to frame 110, or may be attached in a fixed position with respect to frame 110. In one preferred embodiment, brackets 130 are attached to frame 110 in a fixed position such that lights 140 illuminate screen 125 throughout most of the range of motion 150 of brackets 130.

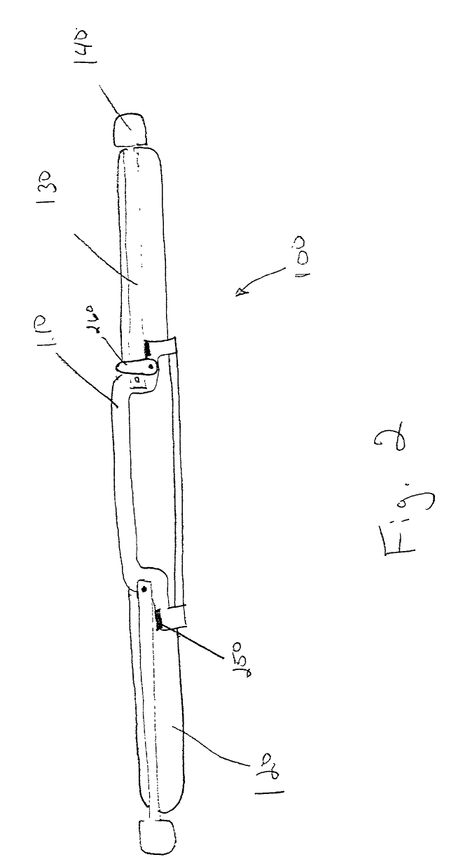

As shown in FIG. 2, brackets 130 and lights 140 may be configured to fold along the sides of gaming device 120 when illuminating device 200 is not in use. In preferred embodiments, brackets 130 and lights 140 are no wider than the depth of gaming device 120, so that brackets 130 and lights 140 will not protrude above or below gaming device 120 when positioned as shown in FIG. 2. However, brackets 130 and lights 140 may have any convenient width.

In some embodiments, frame 110 is configured to hold brackets 130 in place when illuminating device 200 is not in use. For example, frame 110 may be configured to hold brackets 130 in a position such that a plane including both arms of one of brackets 130 is roughly parallel to a long axis of gaming device 120, such that brackets 130 conform with one or more sides of gaming device 120, or both. One such configuration is shown in FIG. 2, wherein tabs 250 prevent further downward motion of brackets 130. Some embodiments of illuminating device 200 are configured to provide an interference fit between frame 110 and brackets 130, such that the friction between frame 110 and brackets 130 tends to keep brackets 130 in place when they are folded as shown in FIG. 2. Some embodiments of illuminating device 200 include hasp 260, a latch or a similar locking mechanism for holding brackets 230 in place when they are folded as shown in FIG. 2.

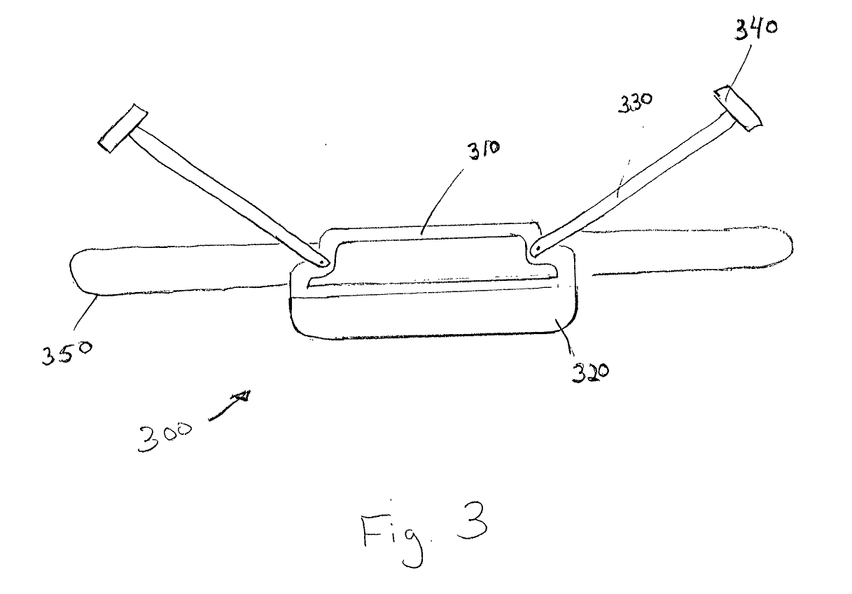

FIG. 3 illustrates an embodiment of illuminator 300 in which frame 310 includes battery pack 320, which is configured to accommodate a battery. Such embodiments have the advantage of not requiring power from gaming device 350 for lights 340, allowing longer use of gaming device 350 between recharging or battery replacement.

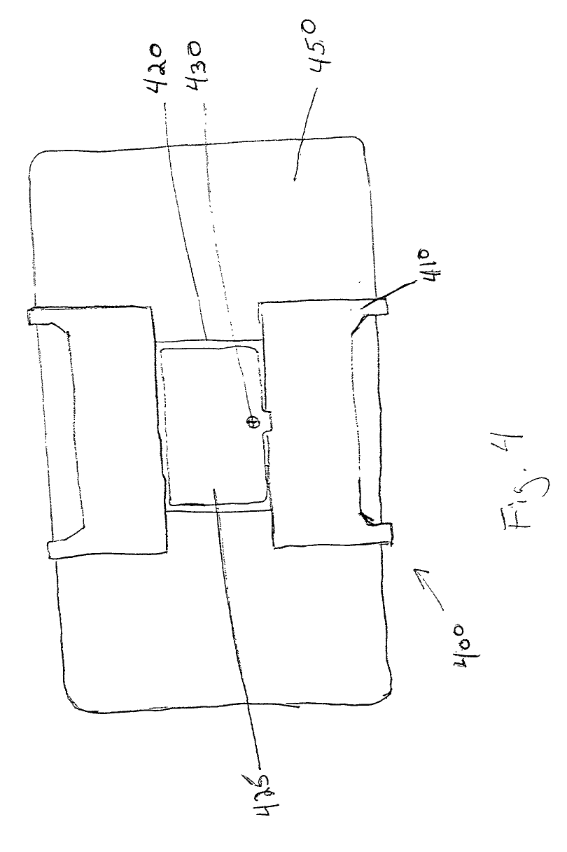

FIG. 4 shows a bottom view of an embodiment of illuminator 400 which includes battery pack 420. In some preferred embodiments of illuminator 400, battery pack 420 is positioned adjacent to the center of mass of gaming device 450. In some preferred embodiments of illuminator 400, the centroid of battery pack 420 is positioned adjacent to the center of mass of gaming device 450. In some preferred embodiments of illuminator 400, battery pack 420 is positioned adjacent to the centroid of gaming device 450. The embodiment shown in FIG. 4 includes door 425 which opens to accommodate a battery and screw 430 for holding door 425 closed. In other embodiments, door 425 is held closed in other ways, for example, by a latch, a hasp, or a sliding tab.

FIG. 5 is a perspective view of one embodiment of the present invention. Brackets 530 are holding lights 540 in an off-axis position with respect to screen 503 of gaming device 505. As shown, lights 540 may be positioned to avoid obstructing a user's view of the screen, while providing light at an angle which reduces glare as compared to lighting from above the screen. In this embodiment, each one of lights 540 includes only one of light sources 545, one of which is shown in FIG. 5. Brackets 530 attach to both ends of lights 540 and are attached to opposing sides of frame 510. In the embodiment illustrated in FIG. 5, frame 510 includes battery pack 520 for providing electrical power to light sources 545.

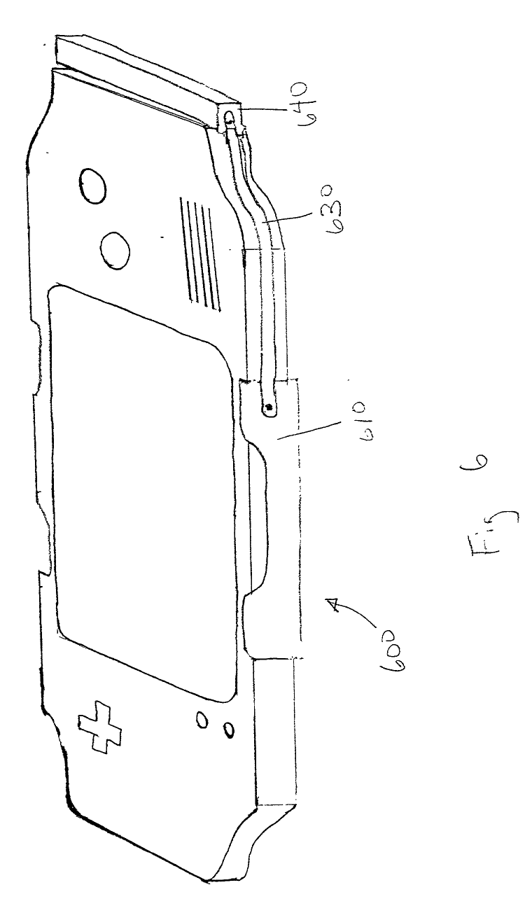

Although the preferred embodiments of the present invention include more than one bracket and illuminator, some embodiments of the present invention have only one bracket. One such embodiment is shown in FIG. 6. Here, illumination device 600 includes light 640, which is attached to frame 610 by way of a single arm 630; there is no arm 630 attached to the opposing side of light 640. In other embodiments with a single bracket, the bracket includes two arms, one of which attaches to each end of light 640.

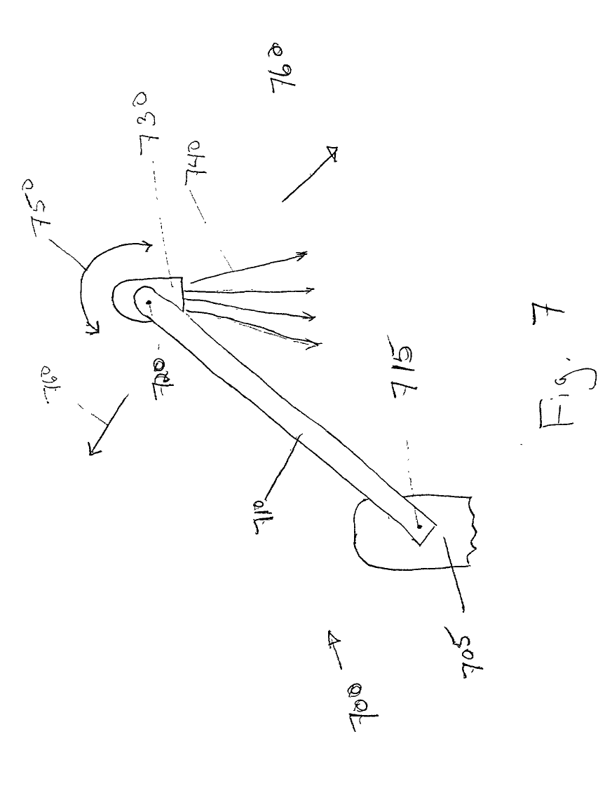

As illustrated in FIG. 7, illuminating device 700 includes light 730 which may be rotated with respect to bracket 710. Only a portion of frame 705 of illuminating device 700 is shown in FIG. 7. Bracket 710 is attached for rotation to frame 705 by pin 715 and may be moved through range of motion 760. Light 730 is attached for rotation to bracket 710 by pin 720. As shown in FIG. 7, light 730 may be moved to various positions within range of motion 750 such that light rays 740 are not necessarily emitted along bracket 710.

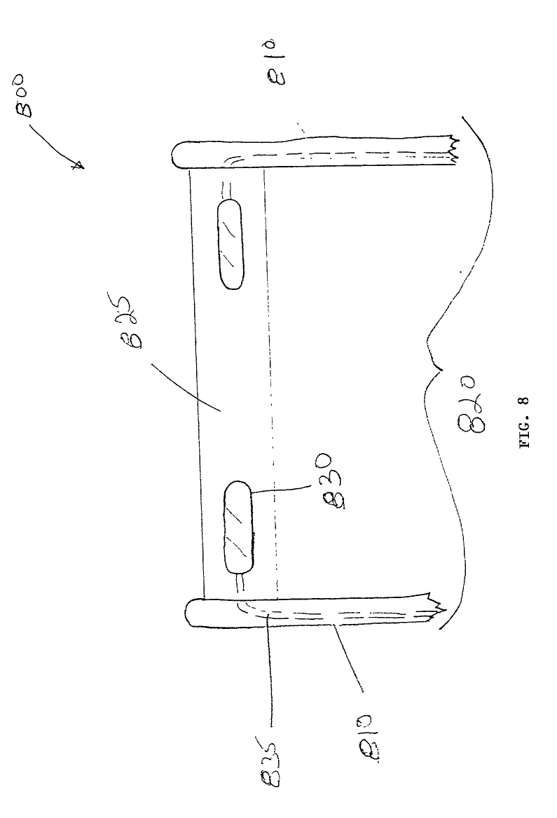

FIG. 8 illustrates a portion of illuminating device 800. Only a portion of bracket 820 is shown. Light 825, which is mounted for rotation to arms 810 of bracket 820, has been rotated to a position such that the light emitted from light sources 830 would shine out of FIG. 8 in the direction of the viewer. Light sources 830 may include any convenient light source, such as an incandescent bulb, a white or colored LED, a xenon bulb or a halogen bulb. Although two light sources 830 are shown in light 828, any convenient number of light sources 830 may be used. Wires 835, disposed within light 828 and arms 810, conduct electricity from a power source to light sources 830. The power source may be a battery disposed within battery pack 420, a battery of the gaming device or another convenient power source.

Referring now to FIG. 9, a preferred embodiment of a positioning device for brackets of the illuminating device is shown. A portion of frame 910 and a portion of arm 930 are shown. Arm 930 is attached to frame 910 by a pin or similar device which fits through openings 915 and 935, thereby engaging grooved portions 920, which cooperate to hold arm 930 in position relative to frame 910.

As shown in enlarged portion 940, grooved portions 920 include a series of alternating ridges 945 and grooves 950. When ridges 945 of grooved portion 920 of arm 930 are fitted to grooves 950 of grooved portion 920 of frame 910, arm 930 is held securely in place. In embodiments wherein grooved portions 920 contain a large number of ridges 945 and grooves 950, arm 930 may be moved to a wide variety of positions wherein arm 930 is held securely in place. Although FIG. 9 indicates grooved portions 920 which consist of straight lines emanating from a center, in other embodiments grooved portions 920 are curved, chevrons, or have other shapes.

FIG. 10 shows another preferred embodiment of a positioning device for brackets of the illuminating device. A portion of frame 1010 and a portion of arm 1030 are shown. When arm 1030 is attached to frame 1010 by a pin or similar device which fits through openings 1015 and 1035, tab 1020 fits into one of slots 1040, thereby holding arm 1030 in position relative to frame 1010. Although only 3 slots 1040 are shown in FIG. 10, other embodiments include more slots 1040. In addition, some embodiments include more than one tab 1020, which adds to the stability of arm 1030. Still other embodiments have tabs on frame 1010 and slots on arm 1030, or alternating slots and tabs on both frame 1010 and arm 1030.

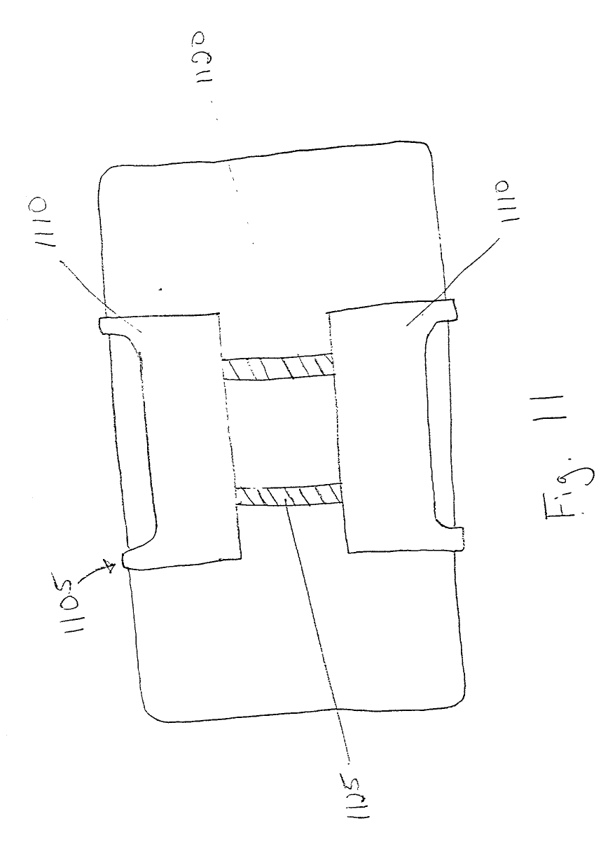

FIG. 11 is a bottom view of an embodiment in which frame 1105 includes side portions 1110 and straps 1125. In some embodiments, side portions 1110 are relatively more rigid than straps 1125: such side portions 1110 may be made of plastic, vinyl or similar material, whereas straps 1125 are preferably fashioned of more flexible material such as nylon, polyester, rayon or cotton. In some embodiments, straps 1125 include elastic material such as rubber for applying tension to side portions 1110, thereby engaging frame 1105 with gaming device 1120.

While the best mode for practicing the invention has been described in detail, those of skill in the art will recognize that there are numerous alternative designs, embodiments, modifications and applied examples which are within the scope of the present invention. Accordingly, the scope of this invention is not limited to the previously described embodiments.

I claim:

1. An illuminating apparatus for a hand-held electronic device, comprising:
a frame configured to be attached to the hand-held electronic device;
a first bracket attached for rotation to the frame, the first bracket being rotatable from a first position above the hand-held electronic device to a second position adjacent to and in conformity with a second side and a third side of the hand-held electronic device; and
a light source attached to the first bracket.

2. The apparatus of claim 1, further comprising a second bracket attached for rotation to the frame, the second bracket being rotatable from a third position above the hand-held electronic device to a fourth position adjacent to and in conformity with the third side and a fourth side of the hand-held electronic device.

3. The apparatus of claim 1, wherein the light source is rotatably attached to the first bracket.

4. The apparatus of claim 1, wherein the light source comprises a xenon lamp.

5. The apparatus of claim 1, wherein the frame comprises a single piece of plastic which can be expanded to accommodate opposing sides of the hand-held electronic device and which contracts to attach to the hand-held electronic device.

6. The apparatus of claim 1, wherein the frame comprises an elastic strap for attaching the frame to the hand-held electronic device.

7. The apparatus of claim 1, further comprising a positioning device for holding the first bracket in a plurality of positions which include the first position and the second position.

8. The apparatus of claim 1, further comprising a battery pack for attaching a battery to the frame.

9. The apparatus of claim 7, wherein the positioning device comprises at least one tab which projects from the first bracket and engages with one of a plurality of slots in the frame.

10. The apparatus of claim 7, wherein the positioning device comprises at least one tab which projects from the frame and engages with one of a plurality of slots in the first bracket.

11. The apparatus of claim 7, wherein the positioning device comprises a plurality of cooperating ridges and grooves formed in the first bracket and the frame, wherein the cooperating ridges and grooves extend radially from an axis about which the first bracket rotates.

12. The apparatus of claim 8, wherein the battery pack is configured to attach the battery adjacent to the center of mass of the hand-held electronic device.

13. An illuminating apparatus for a hand-held gaming device, comprising:
a frame configured to be attached to the hand-held gaming device;
a first bracket attached for rotation to the frame, the first bracket being rotatable from a first position above the hand-held gaming device to a second position adjacent to and in conformity with a second side and a third side of the hand-held gaming device;
a second bracket attached for rotation to the frame, the second bracket being rotatable from a third position above the hand-held gaming device to a fourth position adjacent to and in conformity with the third side and a fourth side of the hand-held gaming device;
a first light source attached to the first bracket;
a second light source attached to the second bracket;
a positioning device for holding the first bracket in a plurality of positions which include the first position and the second position, wherein the positioning device comprises at least one tab which projects from the first bracket and engages with a plurality of slots in the frame; and
a battery pack for attaching a battery to the frame, wherein the battery pack is configured to attach the battery adjacent to the center of mass of the hand-held gaming device.
